(19) United States
(12) Patent Application Publication
(10) Pub. No.: US 2015/0010749 A1
(43) Pub. Date: Jan. 8, 2015

(54) TRANSPARENT CONDUCTIVE LAMINATE, METHOD FOR PRODUCTION OF SAME, ELECTRONIC PAPER USING SAME AND TOUCH PANEL USING SAME

(71) Applicant: TORAY INDUSTRIES, INC., TOKYO (JP)

(72) Inventors: Takashi Oi, Otsu-shi (JP); Osamu Watanbe, Otsu-shi (JP); Naoki Imazu, Otsu-shi (JP)

(73) Assignee: TORAY INDUSTRIES, INC., TOKYO (JP)

(21) Appl. No.: 14/375,340

(22) PCT Filed: Jan. 28, 2013
(86) PCT No.: PCT/JP2013/051718

§ 371 Date: Jul. 29, 2014

(30) Foreign Application Priority Data
Jan. 31, 2012 (JP) 2012-017878

(51) Int. Cl. H01B 1/04; G06F 3/041; H01B 13/30; G02F 1/1343

(52) U.S. Cl. CPC H01B 1/04; G02F 1/13439; G06F 3/041; H01B 13/30
USPC 428/329; 428/323; 428/331; 428/408; 427/108

(57) ABSTRACT

A transparent electroconductive laminate in which condition [A] and/or [B] is satisfied; and the proportion of the surface resistance value after being subjected to a 1-hour wet heat treatment at 60° C. and a relative humidity of 90% and then being left standing for 3 minutes at 25° C. and a relative humidity of 50%, relative to the surface resistance value before the treatment, is 0.7 to 1.3. A method for manufacturing same, electronic paper using same, and a touch panel using same. [A] The white reflectance is from greater than 70% and to no greater than 85%, and the surface resistance value is 1.0×10²Ω/□ to 1.0×10⁴Ω/□. [B] The total light transmittance is greater than 88% and no greater than 93%, and the surface resistance value is 1.0×10²Ω/□ to 1.0×10⁴Ω/□.

### CROSS REFERENCE TO RELATED APPLICATIONS

This is the U.S. National Phase application of PCT/JP2013/051718, filed Jan. 28, 2013, which claims priority to Japanese Patent Application No. 2012-017878, filed Jan. 31, 2012, the disclosures of each of these applications being incorporated herein by reference in their entireties for all purposes.

### FIELD OF THE INVENTION

The present invention relates to a transparent conductive laminate, a method for production of the same, an electronic paper using the same and a touch panel using the same. More particularly, the present invention relates to a transparent conductive laminate having excellent transparent conductivity, heat resistance stability and moist-heat resistance stability, a method for production of the same, an electronic paper using the same and a touch panel using the same.

### BACKGROUND OF THE INVENTION

Carbon nanotubes have a substantially cylindrical shape obtained by winding one sheet of graphite. Carbon nanotubes obtained by winding one sheet of graphite in a single layer are referred to as “single-walled carbon nanotubes” and those which are obtained by winding one sheet of graphite in multiple layers are referred to as “multi-walled carbon nanotubes”. Among multi-walled carbon nanotubes, in particular, ones which are obtained by winding one sheet of graphite in two layers are referred to as “double-walled carbon nanotubes”. Carbon nanotubes have themselves excellent true conductivity and are, therefore, expected to be used as conductive materials.

In order to prepare a transparent conductive laminate including a carbon nanotube, a carbon nanotube is required to be dispersed in a dispersion liquid and generally, an ionic dispersant having excellent dispersibility is used therefor.

However, an ionic dispersant is generally an insulative substance and reduces the conductivity of the resulting carbon nanotube transparent conductive laminate. In addition, since an ionic dispersant has an ionic functional group, there is a problem that it is easily affected by environmental changes such as high temperature and high humidity and thus has poor resistance stability. Therefore, in order to prepare a transparent conductive laminate having high transparent conductivity and excellent resistance stability, it is believed necessary or at least advantageous to remove such ionic dispersant from carbon nanotube layer.

For example, Patent Document 1 discloses a method of producing a conductive film having high conductivity by coating a film with a carbon nanotube dispersion liquid and then rinsing the resultant with water to remove excess ionic dispersant.

Further, in Patent Document 2, there is disclosed an example where, in order to stabilize the resistance of a carbon nanotube transparent conductive laminate, an undercoat layer composed of a melamine resin is formed underneath a carbon nanotube layer, thereby improving the resistance stability.

Further, in Patent Document 3, there is disclosed an example where, in a transparent conductive laminate including indium tin oxide (ITO) as an electric conductor, in order to improve the adhesion between a polymer substrate and an ITO layer which is an inorganic oxide, nitride or oxide of silicon or aluminum is provided as an undercoat layer between the polymer substrate and the ITO layer.

Many studies have been conducted heretofore on the method for dispersing carbon nanotubes having good dispersibility. Uniform dispersion of carbon nanotubes in a solvent can be relatively easily achieved, and various kinds of methods for evaluation of dispersibility thereof have been studied.

For example, Patent Document 4 describes an example of observing a rope shape, a handle assembly state of carbon nanotubes on a substrate in scanning electron microscope observation.

Patent Document 5 describes an example of a transparent conductive laminate in which dispersibility is improved by taking advantage of a repulsive group with a carboxylic acid ionized by making pH of a carbon nanotube dispersion liquid basic.

Further, Patent Document 6 describes an example of quantitatively calculating a bundle diameter of a carbon nanotube observed by scanning electron microscope observation.

### Patent Documents

Patent Document 1: JP 2009-149516 A

Patent Document 2: WO 2009/107758

Patent Document 3: JP 2010-5817 A

Patent Document 4: JP 2008-108575 A

Patent Document 5: JP 2009-508292 A

Patent Document 6: JP 2009-29695 A

### SUMMARY OF THE INVENTION

In Patent Document 1, there is no disclosure with regard to heat resistance stability and moist-heat resistance stability. In addition, the step of rinsing with water imposes high environmental stress; therefore, it may present a significant hurdle for mass-production property and stabilization of mass production.

In the technology disclosed in Patent Document 2, a melamine resin is employed as an undercoat layer; however, the heat resistance stability is not sufficient.

The ITO constituting the conductive layer described in Patent Document 3 is an inorganic substance whose properties are not impaired in the temperature and humidity ranges which a macromolecule, the substrate, can withstand and there is also no disclosure with regard to heat resistance stability and moist-heat resistance stability.

In Patent Document 4, the preferred bundle diameter on a substrate is 20 to 100 nm, but it is not sufficient as a uniform carbon nanotube dispersion.

In Patent Document 5, the preferred bundle diameter on a substrate is less than 20 nm, but specific achievement means is not shown.

In Patent Document 6, an average of bundle diameters of carbon nanotubes is 20 nm or less, but a carbon nanotube sample coated on a substrate is not used in scanning electron microscope observation, and a bundle diameter on the substrate is not directly reflected.

The present invention was made in view of the above-described problems and circumstances and provides a transparent conductive laminate having excellent heat resistance stability and moist-heat resistance stability as well as excellent transparent conductivity.

In order to solve the above-described problems, the transparent conductive laminate according to an embodiment of the present invention has the following constitution. That is, the transparent conductive laminate according to an embodiment of the present invention includes:

a transparent conductive laminate which includes an undercoat layer containing an inorganic oxide and a conductive layer containing a carbon nanotube in this order on a transparent substrate, wherein at least one of the following conditions [A] and [B] is satisfied and the ratio of the surface resistance after subjecting the transparent conductive laminate to a 1-hour moist-heat treatment at a temperature of 60° C. and a relative humidity of 90% and then leaving the resultant to stand for 3 minutes at a temperature of 25° C. and a relative humidity of 50% is 0.7 to 1.3 with respect to the surface resistance prior to the treatment:

[A] The white reflectance is more than 70% and not more than 85% and the surface resistance is not less than 1.0×10²Ω/□ and not more than 1.0×10⁴Ω/□.
[B] The total light transmittance is more than 88% and not more than 93%, and the surface resistance is not less than 1.0×10²Ω/□ and not more than 1.0×10⁴Ω/□.

The method for production of a transparent conductive laminate according to an embodiment of the present invention has the following constitution. That is, the method for production of a transparent conductive laminate according to an embodiment of the present invention includes:

a method for production of a transparent conductive laminate, which includes: an undercoat layer forming step of providing an undercoat layer having a solid surface zeta potential of +30 to −30 mV (hereinafter, abbreviated as an “undercoat layer forming step” in some cases); a coating step of coating a carbon nanotube dispersion liquid, whose zeta potential is negative, on the undercoat layer (hereinafter, abbreviated as a “coating step” in some cases); and drying step of removing a dispersion medium from the nanotube dispersion liquid coated on the undercoat layer. The coating step and the drying step may be collectively referred to as a carbon nanotube layer forming step.

The electronic paper according to an embodiment of the present invention has the following constitution. That is, the electronic paper according to an embodiment of the present invention includes: an electronic paper including the above-described transparent conductive laminate.

The touch panel according to an embodiment of the present invention has the following constitution. That is, the touch panel according to an embodiment of the present invention includes: a touch panel including the above-described transparent conductive laminate.

In the transparent conductive laminate according to the present invention, the ratio of the surface resistance after subjecting the transparent conductive laminate to a 1-hour heat treatment at a temperature of 150° C. and then leaving the resultant to stand for 24 hours at a temperature of 25° C. and a relative humidity of 50% is preferably 0.7 to 1.3 with respect to the surface resistance prior to the treatment.

In the transparent conductive laminate of the present invention, the average of carbon nanotube bundle diameters on the transparent substrate is preferably 5 nm or less as observed with a scanning electron microscope.

In the transparent conductive laminate of the present invention, the undercoat layer is preferably a complex of silica microparticles or alumina microparticles and a polysilicate.

In the transparent conductive laminate according to the present invention, the diameter of the silica microparticle or alumina microparticle is preferably in the range of 10 nm to 200 nm.

In the method for production of a transparent conductive laminate according to the present invention, the surface roughness Ra of the undercoat layer is preferably 2.0 to 10.0 nm.

In the method for production of a transparent conductive laminate according to the present invention, the water contact angle of the undercoat layer is preferably 5 to 25°, more preferably 5° to 10°.

In the method for production of a transparent conductive laminate according to the present invention, the zeta potential of the carbon nanotube dispersion liquid is preferably −40 to −70 mV.

The undercoat layer forming step is a step of providing an undercoat layer having a solid surface zeta potential of +30 to −30 mV on a transparent substrate, wherein a coating solution for forming an undercoat layer is formed by adopting dry or wet coating. The solid surface zeta potential of the undercoat layer can be adjusted to +30 to −30 mV by selecting a material (such a method will be described in detail in the section of [Undercoat layer]).

A transparent conductive laminate prepared by coating and drying a carbon nanotube dispersion liquid on a transparent substrate has the problem that bundling of carbon nanotubes occurs due to an increase in concentration of the dispersion liquid during drying after coating and generation of an electrostatic repulsive force between the carbon nanotube dispersion liquid and the transparent substrate. In the present invention, it has been found that when carbon nanotubes are negatively charged in a dispersion liquid, and the carbon nanotube dispersion liquid is coated on an undercoat layer having a solid surface zeta potential of +30 to −30 mV, and dried, the carbon nanotubes dispersed in the carbon nanotube dispersion liquid are electrostatically adsorbed to the undercoat layer, so that bundling of the carbon nanotubes occurring during drying on a transparent substrate can be suppressed, leading to the present invention. Consequently, a transparent conductive laminate having superior transparent conductivity as compared to conventional ones can be obtained.

According to the present invention, there is provided a transparent conductive laminate having excellent heat resistance stability and moist-heat resistance stability as well as excellent transparent conductivity.

### BRIEF DESCRIPTION OF THE DRAWINGS

FIG. 1 is a drawing which illustrates a method of measuring the white reflectance.

FIG. 2 is one example of an image showing the surface of an undercoat layer in the present invention, which was taken under an atomic force microscope (hereinafter, referred to as “AFM”).

FIG. 3 is a schematic diagram showing a chemical vapor deposition apparatus used in the present invention.

FIG. 4 is one example of a scanning electrode microscope in Example 4.

FIG. 5 is one example of a scanning electrode microscope in Comparative Example 2.

FIG. 6 is a histogram of a bundle diameter calculated from a scanning microscope image in Example 4.

FIG. 7 is a histogram of a bundle diameter calculated from a scanning microscope image in Example 5.

FIG. 8 is a histogram of a bundle diameter calculated from a scanning microscope image in Comparative Example 2.

### DETAILED DESCRIPTION OF EMBODIMENTS OF THE INVENTION

The transparent conductive laminate of an embodiment of the present invention is a transparent conductive laminate which includes an undercoat layer containing an inorganic oxide and a carbon nanotube in this order on a transparent substrate, wherein at least one of the following conditions [A] and [B] is satisfied and the ratio of the surface resistance after subjecting the transparent conductive laminate to a 1-hour moist-heat treatment at a temperature of 60° C. and a relative humidity of 90% and then leaving the resultant to stand for 3 minutes at a temperature of 25° C. and a relative humidity of 50% is 0.7 to 1.3 with respect to the surface resistance prior to the treatment.

[A] The white reflectance is more than 70% and not more than 85% and the surface resistance is not less than 1.0×10²Ω/□ and not more than 1.0×10⁴Ω/□.
[B] The total light transmittance is more than 88% and not more than 93%, and the surface resistance is not less than 1.0×10²Ω/□ and not more than 1.0×10⁴Ω/□.

When the transparent conductive laminate of the present invention is used for electronic devices having a transparent conductive laminate, such as electronic papers and touch panels, visibility of the device can be improved owing to the configuration described above. Because the transparent conductive laminate has a high resistance stability, these devices can be stably operated in any environment.

the term “transparent conductive laminate” refers to a laminate having, on a transparent substrate, at least one layer formed by a wet coating method or a dry coating method and containing a conductive material. The present invention optionally uses a conductive layer containing carbon nanotubes as a conductive material.

### [Transparent Substrate]

Examples of the material of the transparent substrate used in the present invention include resins and glasses. As the resin, for example, a polyester such as polyethylene terephthalate (PET) or polyethylene naphthalate (PEN), a polycarbonate (PC), a polymethyl methacrylate (PMMA), a polyimide, a polyphenylene sulfide, an aramid, a polypropylene, a polyethylene, a polylactic acid, a polyvinyl chloride, a polymethyl methacrylate, an alicyclic acrylic resin, a cycloolefin resin or a triacetylcellulose may be employed. As the glass, an ordinary soda glass may be employed. Further, a plurality of these transparent substrates may be used in combination as well. For example, the transparent substrate may be one which is composed of a combination of a resin and a glass or a complex transparent substrate such as one obtained by laminating two or more resins. The transparent substrate may also be one in which a hardcoat is arranged on a resin film. The type of the transparent substrate is not restricted to those described in the above and the most appropriate one can be selected in accordance with the intended use as well as from the standpoints of the durability, cost and the like. The thickness of the transparent substrate is not particularly restricted; however, in cases where it is used in an electrode related to a display such as a touch panel, a liquid crystal display, an organic electroluminescence or an electronic paper, the thickness of the transparent substrate is preferably in the range of 10 μm to 1,000 μm.

### [Undercoat Layer]

In the method for production of a transparent conductor according to an embodiment of the present invention, an undercoat layer having a solid surface zeta potential of +30 to −30 mV is provided on the above-described transparent substrate. Preferably, a material containing an inorganic oxide is used as a material of the undercoat layer having a solid surface zeta potential of +30 to −30 mV. Further, it is preferred that the undercoat layer have high hydrophilicity. For hydrophilicity, specifically the water contact angle is in the range of 5 to 25° is preferred. Preferably, a material containing an inorganic oxide is used as a material of the undercoat layer having a water contact angle of 5 to 25°. Materials containing titania, alumina, silica and ceria among inorganic oxides are preferred. These substances are preferred because they have a hydrophilic group-OH group on the surface and high hydrophilicity can be thus attained. It is preferred that the material of the undercoat layer have hydrophilicity because a dispersant, which is an insulative material contained in the carbon nanotube layer, is preferentially adsorbed to the undercoat layer, so that conductivity of the carbon nanotube layer is improved. Further, it is more preferred that the undercoat layer is a complex of silica microparticles and a polysilicate or a complex of alumina microparticles and a polysilicate. The polysilicate is used as a binder for microparticles, and provided for the purpose of fixing microparticles on the substrate. The polysilicate in the present invention is a generic name formed by a step in which a substance represented by the following formula (1) and/or a solution containing a substance represented by the following formula (1) is coated and dried.

(R₁)ₙSi(OR₂)₄₋ₙ (1)

wherein R₁ is one or more groups selected from a hydrogen atom, an alkyl group, an acyl group, a vinyl group, an allyl group, a cyclohexyl group, a phenyl group, an epoxy group, a (meth)acryloxy group, an ureido group, an amide group, a fluoroacetamide group, an isocyanate group and a substituted derivative thereof and n is the same or different when n is not less than 2; R₂ is one or more groups selected from a hydrogen atom, an alkyl group, an acyl group, a vinyl group, an allyl group, a cyclohexyl group, a phenyl group, an epoxy group, a (meth)acryloxy group, an ureido group, an amide group, a fluoroacetamide group, an isocyanate group and a substituted derivative thereof; and n is not less than 0 and not more than 4.

Concurrently with vaporization of a solvent, dehydration condensation occurs at a moiety, in which R₂ of the OR₂ group is a hydrogen atom, in the step of drying the solution containing the substance of the formula (1), so that the molecule is enlarged, leading to formation of a polysilicate.

The surface roughness Ra is an arithmetic mean of distances (absolute values) from the center line of surface irregularities, and can be calculated by measuring the surface of the undercoat layer with an AFM (Shimadzu, SPM 9600 etc.) and then performing roughness analysis using software attached to the apparatus.

It is more preferred that the surface of the undercoat layer has surface irregularities in a certain range. When as an undercoat substrate, one including microparticles of an inorganic oxide is used, the surface of the undercoat layer have a large number of projections associated with these particles. When coarse projections are present, it is aggregates of particles that form such projections, and surface charges may be relatively low because the surface areas of particles that effectively act are small relative to the content of particles. Thus, it is believed that by removing such coarse projections to make surface irregularities smaller, the surface uniformity is enhanced, so that distribution unevenness of surface charges can be eliminated. On the other hand, by making surface irregularities larger, the area of the undercoat layer to which the dispersant can be transferred is increased, so that the amount of the dispersant transferred can be increased. As a result, the transparent conductivity and the moist-heat resistance stability of the transparent conductive laminate described later can be further improved. It is more preferred that as a means for providing irregularities in a certain range, the undercoat layer has a complex of silica or alumina microparticles and a polysilicate as a main component. With such a configuration, an undercoat layer having high hydrophilicity and including irregularities can be easily and conveniently prepared. Thus, the surface roughness Ra of the undercoat layer is preferably in the range of 2.0 to 10.0 nm from the viewpoint of uniformity of a solid surface zeta potential and improvement of a dispersant adsorption area. The diameter of the silica microparticle or alumina microparticle for achieving a surface roughness in the above-mentioned range is preferably in the range of 10 to 200 nm.

### [Water Contact Angle of Undercoat Layer]

The water contact angle can be measured using a commercially available contact angle measuring apparatus. In the measurement of the water contact angle, in accordance with JIS R 3257 (1999), in an atmosphere having a room temperature of 25° C. and a relative humidity of 50%, 1 to 4 μL of water is dropped onto the undercoat layer surface using a syringe and a droplet is observed from a horizontal cross-section to determine the angle created between a tangent line of the droplet edge and the film plane.

The method for forming an undercoat layer on a transparent substrate will be described.

### [Transparent Conductivity]

The transparent conductive laminate of the present invention preferably has excellent transparent conductivity. The term “transparent conductivity” means that transparency and conductivity are attained at the same time, and the term “excellent conductivity” in the present invention means that at least one of the following conditions [A] and [B] is satisfied.

[A] The white reflectance is more than 70% and not more than 85% and the surface resistance is not less than 1.0×10²Ω/□ and not more than 1.0×10⁴Ω/□.
[B] The total light transmittance is more than 88% and not more than 93%, and the surface resistance is not less than 1.0×10²Ω/□ and not more than 1.0×10⁴Ω/□.

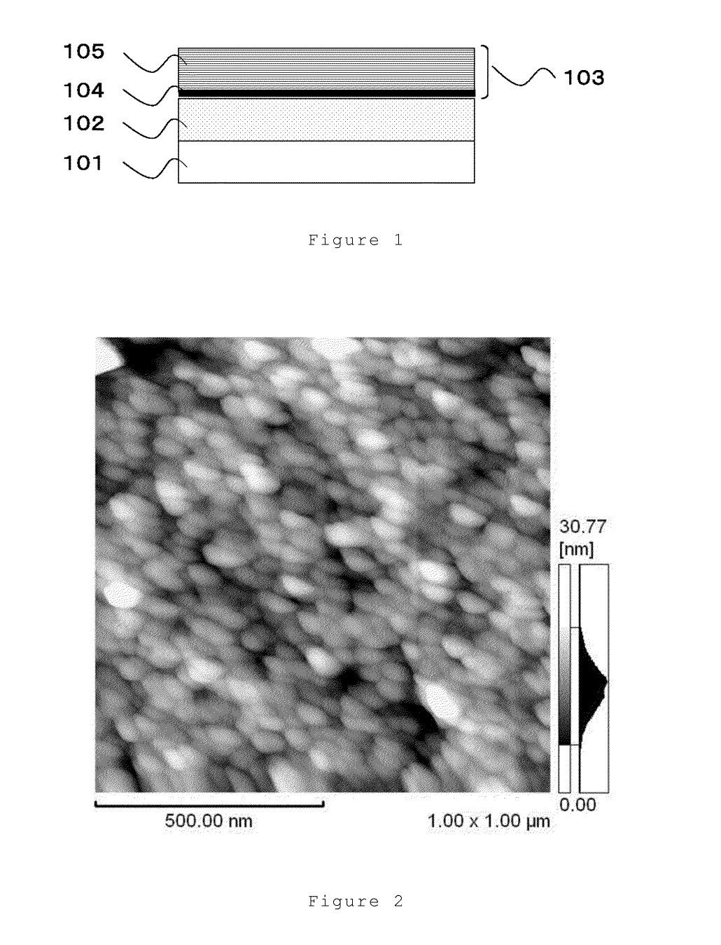

A typical example of the index of the transparency is a total light transmittance. The total light transmittance is preferably more than 88% and not more than 93%. In the present invention, as an index of transparency, the white reflectance may be used in addition to the total light transmittance. The “white reflectance” in the present invention (hereinafter, indicated as the “white reflectance”) represents a ratio of the reflected light to the incoming light when a white reflection plate 101, an adhesive layer 102 and a transparent conductive laminate 103 are laminated as shown in FIG. 1 and a light having a wavelength of 550 nm is irradiated from the side of the transparent conductive laminate. As long as the thickness of this adhesive layer is in the range of 20 μm to 40 μm and the refractive index is in the range of 1.4 to 1.6, the transparent conductive laminate is suitable for the measurement of the white reflectance prescribed in the present invention. The material of the adhesive is not particularly restricted as long as the thickness of the adhesive layer and the reflective index are in the above-described respective ranges. For example, materials such as acryls, urethanes, olefins, celluloses, ethylene-vinyl acetates, epoxy-based materials, vinyl chlorides, chloroprene rubbers, vinyl acetates, cyanoacrylates, silicones, phenol resins, polyimides, polystyrenes and melamines may be employed as appropriate. The white reflectance is preferably more than 70% and not more than 85%.

As the above-described index of the transparency, the total light transmittance of a laminate including a transparent substrate, an undercoat layer, a carbon nanotube layer and a later-described overcoat layer (as necessary) is practically meaningful. Accordingly, the index can be used when a relative comparison is performed with a laminate of a certain overcoat layer (when the overcoat layer is adopted) and undercoat layer. However, since the light reflectance of the conductive surface as well as the total light transmittance vary depending on the refractive indices of the overcoat layer and undercoat layer, it is preferred to use the white reflectance as an index when carbon nanotube layers alone are compared.

### [Moist-Heat Resistance Stability]

The transparent conductive laminate of an embodiment of the present invention satisfies the above-described conductivity and has excellent moist-heat resistance stability. In the present invention, as an index of the moist-heat resistance stability, the ratio of the surface resistance after subjecting the transparent conductive laminate to a 1-hour moist-heat treatment at a temperature of 60° C. and a relative humidity of 90% and then leaving the resultant to stand for 3 minutes at a temperature of 25° C. and a relative humidity of 50% with respect to the surface resistance prior to the treatment is employed. In the transparent conductive laminate according to the present invention, this moist-heat resistance stability is preferably 0.7 to 1.3, more preferably 0.8 to 1.2. When the moist-heat resistance exceeds the above-mentioned range, operations of an electronic device using the transparent conductive laminate may be hindered. For example, display unevenness may occur in the case of an electronic paper and a liquid crystal display, and a touch may not be recognized in the case of a touch panel.

### [Heat Resistance Stability]

Further, it is preferred that the transparent conductive laminate of the present invention have excellent heat resistance stability. In the present invention, as an index of the heat resistance stability, the ratio of the surface resistance after subjecting the transparent conductive laminate to a 1-hour heat treatment at a temperature of 150° C. and then leaving the resultant to stand for 24 hours at a temperature of 25° C. and a relative humidity of 50% with respect to the surface resistance prior to the treatment is employed. Here, the relatively humidity is not controlled in the heat treatment at 150° C.; however, since the saturated water vapor pressure at 150° C. is 4.8 atm and the saturated water vapor pressure at 25° C., which is normal temperature, is 0.03 atom, even if the relative humidity varies at normal temperature, when the temperature is increased to 150° C., the relative humidity can be regarded to be substantially 0%. In transparent conductive laminate according to the present invention, the heat resistance stability is preferably 0.7 to 1.3, more preferably 0.8 to 1.2. When the transparent conductive laminate of the present invention is used as a member of an electronic device, a metallic paste electrode for formation of an electric circuit, an insulating paste are coated on the conductive surface of the transparent conductive laminate, and heat-cured at a temperature of approximately 100 to 150° C. It is preferred that the heat resistance stability be in the above-described range because a change in resistance during the heat curing decreases, so that an electronic device having more stable quality can be designed and produced.

### [Method for Production of Transparent Conductive Laminate]

The method for producing a transparent conductive laminate according to the present invention includes: an undercoat layer forming step of providing on a transparent substrate an undercoat layer containing an inorganic oxide; a coating step of coating on the undercoat layer a carbon nanotube dispersion liquid containing a dispersant (hereinafter, simply referred to as “dispersion liquid” in some cases); and a drying step of removing a dispersion medium from the carbon nanotube dispersion liquid containing a dispersant.

In the step of forming an undercoat layer, dry coating or wet coating can be adopted. Preferably, the undercoat layer has a thickness of 1 to 120 nm.

In the coating step, in order to form a carbon nanotube layer on the undercoat layer, a carbon nanotube dispersion liquid containing a dispersant is provided by wet coating. The carbon nanotube dispersion liquid used here is a mixture of a carbon nanotube, a dispersant and a dispersion medium, which is water, and it is preferred that the dispersant be contained at a mass ratio of 0.5 to 9 with respect to the carbon nanotube. It is preferred that this dispersion liquid be coated on the undercoat layer such that the amount of the carbon nanotube after drying becomes 0.1 to 5 mg/m².

Examples of the step of drying to remove a dispersion medium from the coated carbon nanotube dispersion liquid, which is performed after the coating step, include convective hot-air drying in which hot air is blown to a substrate; radiation electrothermal drying in which a substrate is allowed to absorb infrared radiation irradiated from an infrared dryer and the thus absorbed infrared radiation is converted to heat so as to dry the substrate by the heat; and conductive electrothermal drying in which drying is performed by thermal conduction from a wall surface heated by a heating medium. Thereamong, convective hot-air drying is preferred since the drying rate is high.

Further, in the present invention, it is preferred that the dispersant be transferred to the above-described undercoat layer in the above-described coating step and/or drying step.

Generally, in a carbon nanotube dispersion liquid, due to high π-electron interaction working between the side walls of carbon nanotubes, the carbon nanotubes are likely to aggregate into a bundle state. By coating a dispersion liquid in which this bundle state is resolved and carbon nanotubes are separated from one another and dispersed, the conductivity of the resulting carbon nanotube layer is expected to be improved. Further, the longer the carbon nanotubes, the more the number of contact points among the carbon nanotubes is increased, so that the conductivity of the resulting carbon nanotube layer is improved. However, in a transparent conductive laminate prepared by coating and then drying a carbon nanotube dispersion liquid on a transparent substrate, while an increased amount of dispersant in the dispersion liquid contributes to an improvement in the conductivity by resolving the above-described bundle state and preventing carbon nanotubes from breaking at the time of their dispersion, there is a problem that these effects are canceled as the use of such dispersion liquid leads to an increase in the ratio of the dispersant, an insulative material, in the resulting carbon layer, adversely affecting the conductivity. Furthermore, an increase in the amount of dispersant contained in the carbon nanotube layer also has a problem in that the resistance stability of the resulting transparent conductive laminate is deteriorated when it is heat-treated or placed in a high-temperature and high-humidity condition. In a preferred mode of the present invention, the amount of dispersant in the dispersion liquid is increased to have carbon nanotubes in a highly dispersed state and inhibit their breakage and, in the step of coating and/or drying the carbon nanotube dispersion liquid on a hydrophilic undercoat layer, the dispersant is transferred to the undercoat layer, thereby the amount of the dispersant in the resulting carbon nanotube layer can be reduced and a transparent conductive laminate having superior transparent conductivity and resistance stability as compared to before can be obtained.

For achieving a higher transmittance in a transparent conductive laminate using carbon nanotubes, it is advantageous to decrease the coating amount of carbon nanotubes on the substrate. For achieving the above-mentioned purpose in the wet coating method, it is advantageous to adopt any of a method of decreasing the coating thickness (thickness in wet state) of a carbon nanotube dispersion liquid and a method of decreasing the carbon nanotube concentration in the dispersion liquid. However, when the coating thickness of the dispersion liquid is decreased, it is difficult to maintain uniformity of thickness, and therefore, for example in bar coating which is a general wet coating method, it is difficult to coat the dispersion liquid in a thickness of 5 μm or less. On the other hand, when the carbon nanotube concentration is decreased, there is the problem that the viscosity of the dispersion liquid decreases to cause cissing during coating, so that uniform coating cannot be performed. In the present invention, an undercoat containing an inorganic oxide is provided to make the surface of the undercoat hydrophilic, and a dispersion liquid, the viscosity of which is properly adjusted, is uniformly coated on a substrate, thereby making it possible to solve the above-mentioned problem. It is preferred that the water contact angle of the surface of the undercoat be 5 to 25° because the adoptable viscosity range of the dispersion liquid can be further widened, so that the degree of freedom of the composition of the coating solution is increased. By adopting these techniques, the amount of carbon nanotubes present on the substrate is successfully reduced, so that a higher transmittance can be achieved.

### [Method for Forming Undercoat Layer]

In the method for producing a transparent conductive laminate according to the present invention, the method for providing an undercoat layer on a transparent substrate is not particularly restricted. A known wet coating method, for example, spray coating, immersion coating, spin coating, knife coating, kiss coating, gravure coating, slot-die coating, roll coating, bar coating, screen printing, ink-jet printing, pad printing or other type of printing method may be employed. Further, a dry coating method may be employed as well. As the dry coating method, for example, physical vapor growth, such as sputtering or vapor deposition, or chemical vapor deposition can be utilized. Further, the coating may be performed in plural times and two different coating methods may also be used in combination. As the coating method, gravure coating, bar coating and slot die coating, which are wet coating, are preferred.

### [Adjustment of Undercoat Layer Thickness]

The thickness of the undercoat layer is not restricted as long as the dispersant can be transferred thereto at the time of coating the carbon nanotube dispersion liquid. Any thickness at which an anti-reflection effect by optical interference can be effectively attained is preferred since such a thickness allows an improvement in the light transmittance. Accordingly, it is preferred that the thickness of the undercoat layer be, combined with that of the later-described overcoat layer, in the range of 80 to 120 nm.

### [Carbon Nanotube]

The carbon nanotube used in the present invention is not particularly restricted as long as it is one having a substantially cylindrical shape obtained by winding one sheet of graphite. Either of a single-walled carbon nanotube obtained by winding one sheet of graphite in single layer and a multi-walled carbon nanotube obtained by winding one sheet of graphite in multiple layers may be employed; however, preferred thereamong is a carbon nanotube in which at least 50 out of 100 carbon nanotubes are double-walled carbon nanotubes obtained by winding one sheet of graphite in two layers since a such carbon nanotube has extremely high conductivity as well as extremely high dispersibility in a coating dispersion liquid. It is more preferred that at least 75 out of 100 carbon nanotubes be double-walled carbon nanotubes and it is most preferred that at least 80 out of 100 carbon nanotubes be double-walled carbon nanotubes. It is noted here that the condition where 50 out of 100 carbon nanotubes are double-walled carbon nanotubes may be indicated as “the ratio of double-walled carbon nanotube is 50%”. Furthermore, a double-walled carbon nanotube is preferred also from the point that the intrinsic functions such as conductivity are not impaired even when the surface thereof is functionalized by an acid treatment or the like.

The carbon nanotube is produced by, for example, the following procedures. In a vertical reactor, a powder-form catalyst in which iron is supported on magnesia is provided on the entire surface of the reactor in the direction of horizontal cross-section of the reactor. Methane is then supplied to the reactor in the vertical direction so as to bring the thus supplied methane into contact with the above-described catalyst at a temperature of 500 to 1,200° C. After producing a carbon nanotube, the thus obtained carbon nanotube may be subjected to an oxidation treatment to obtain a carbon nanotube containing single-walled to 5-walled carbon nanotubes. After this production, the thus obtained carbon nanotube may be subjected to an oxidation treatment, thereby the ratio of the single-walled to 5-walled carbon nanotubes, particularly the ratio of the double-walled to 5-walled nanotubes, can be increased. This oxidation treatment is performed by using, for example, a nitric acid treatment method. Nitric acid is preferred since it acts as a dopant for carbon nanotubes. A dopant provides a carbon nanotube with excess electrons or functions to deprive electrons to form a hole. A dopant improves the conductivity of a carbon nanotube by generating a carrier capable of moving freely. Conditions for the nitric acid treatment is not particularly restricted as long as the carbon nanotube according to the present invention can be obtained; however, it is usually performed in an oil bath at 140° C. The duration of the nitric acid treatment is also not particularly restricted; however, it is preferably in the range of 5 hours to 50 hours.

In the present invention, as the dispersant of the carbon nanotube, surfactants and variety of dispersants (water-soluble dispersants etc.) may be employed; however, an ionic dispersant having high dispersibility is preferred. Examples of the ionic dispersant include anionic dispersants, cationic dispersants and amphoteric dispersants. Any type of such ionic polymer material may be used as long as it has high carbon nanotube-dispersing capacity and is capable of retaining dispersibility; however, anionic dispersants are preferred since they have excellent dispersibility and dispersion-retaining property. Thereamong, carboxymethylcellulose and salts thereof (such as sodium salt and ammonium salt) and polystyrene sulfonic acid salts are preferred since they are capable of efficiently dispersing the carbon nanotube in a carbon nanotube dispersion liquid.

In the present invention, in cases where a carboxymethylcellulose salt or a polystyrene sulfonic acid salt is used, as the cationic substance constituting the salt, for example, a cation of an alkali metal such as lithium, sodium or potassium; a cation of an alkaline earth metal such as calcium, magnesium or barium; an ammonium ion; an onium ion of an organic amine such as monoethanolamine, diethanolamine, triethanolamine, morpholine, ethylamine, butylamine, coconut oil amine, tallow amine, ethylenediamine, hexamethylenediamine, diethylenetriamine or polyethyleneimine; or a polyethylene oxide adduct thereof can be used; however, the cationic substance constituting the salt is not restricted to these.

As a method for preparing a carbon nanotube dispersion liquid having a negative zeta potential, the surfaces of carbon nanotubes to be used as a raw material are modified and/or a dispersant for carbon nanotubes is selected.

The method of carbon nanotube surface modification treatment for adjusting the zeta potential of a carbon nanotube dispersion liquid is not particularly restricted, but it is preferred to introduce an anionic group such as a carboxyl group or a hydroxyl group into a carbon nanotube side wall by physical treatment such as corona treatment, plasma treatment or frame treatment, or chemical treatment such as acid treatment or alkali treatment. Adjustment of the zeta potential by surface modification can be performed based on the following known idea. That is, Thermochimica Acta 497, 67 (2010) describes that while the zeta potential is in the range of 0 to 20 mV when carbon nanotubes are not subjected to surface modification treatment, the zeta potential can be changed to −10 to −40 mV by performing surface modification treatment. Further, an attempt was made to intensify surface modification treatment conditions, and resultantly it was found that the zeta potential could also be adjusted to −40 to −70 mV.

As a dispersant for carbon nanotubes for adjusting the zeta potential of a carbon nanotube dispersion liquid, any type of such dispersant may be used as long as it has high carbon nanotube-dispersing capacity and is capable of retaining dispersibility. Above all, the anionic dispersants described above are most preferred as the dispersant. In the case where an anionic dispersant is used, when the pH of the carbon nanotube dispersion liquid is in the range of 5.5 to 11, the ionization degrees of acidic functional groups of, for example, carboxylic acid modifying the carbon nanotube surface and carboxylic acid contained in the dispersant surrounding the carbon nanotube are improved, so that the carbon nanotube or the dispersant therearound has a negative zeta potential. More specifically, when surface-modified carbon nanotubes, and carboxymethyl cellulose as a dispersant are used, the zeta potential is −20 mV at a pH of 4.0, whereas the zeta potential is −40 to −70 mV at a pH of 5.5 to 11. As a method for preparing a carbon nanotube dispersion liquid having a negative zeta potential, it is most preferred to select an anionic ionic dispersant for utilizing electrostatic repulsion.

When the carbon nanotube surface modification shown in the foregoing section is combined with the above-mentioned method, not only an anionic dispersant but also a cationic dispersant and an amphoteric dispersant may be used.

In the present invention, it is believed that since electrostatic interaction between the undercoat and carbon nanotubes is utilized, anionic carbon nanotubes present in a carbon nanotube dispersion liquid are drawn to the surface of an undercoat layer which is cationic as compared to the carbon nanotube dispersion liquid, so that a higher-level dispersion state can be achieved by electrostatic adsorption. Accordingly, similarly, cationic carbon nanotubes present in a carbon nanotube dispersion liquid are drawn to the surface of an undercoat layer which is anionic as compared to the carbon nanotube dispersion liquid, so that a higher-level dispersion state can be achieved by electrostatic adsorption.

The weight average molecular weight of the dispersant is preferably 100 or more. When the weight average molecular weight is 100 or more, an interaction with carbon nanotubes is more effectively generated to improve dispersion of carbon nanotubes. Depending on the length of carbon nanotubes, the dispersant interacts with carbon nanotubes to improve dispersibility as the weight average molecular weight increases. For example, in the case of a polymer, very stable dispersion is possible with the polymer entangled with carbon nanotubes as the length of the polymer chain increases. However, when the weight average molecular weight is excessively high, conversely dispersibility is deteriorated, and therefore the weight average molecular weight is preferably 10,000,000 or less, further preferably 1,000,000 or less. The weight average molecular weight is most preferably in the range of 10,000 to 500,000.

The pH of the carbon nanotube dispersion liquid can be adjusted by adding thereto an acidic substance or a basic substance in accordance with the Arrhenius Law. Examples of the acidic substance include, as protonic acids, inorganic acids such as hydrochloric acid, sulfuric acid, nitric acid, phosphoric acid, fluoroboric acid, hydrofluoric acid and perchloric acid; organic carboxylic acids; phenols; and organic sulfonic acids. Further, examples of the organic carboxylic acids include formic acid, acetic acid, nitric acid, benzoic acid, phthalic acid, maleic acid, fumaric acid, malonic acid, tartaric acid, citric acid, lactic acid, succinic acid, monochloroacetic acid, dichloroacetic acid, trichloroacetic acid, trifluoroacetic acid, nitroacetic acid and triphenylacetic acid. Examples of the organic sulfonic acids include alkylbenzenesulfonic acid, alkylnaphthalenesulfonic acid, alkylnaphthalenedisulfonic acid, naphthalenesulfonic acid-formalin polycondensate, melamine sulfonic acid-formalin polycondensate, naphthalenedisulfonic acid, naphthalenetrisulfonic acid, dinaphthylmethanedisulfonic acid, anthraquinonesulfonic acid, anthraquinonedisulfonic acid, anthracenesulfonic acid and pyrenesulfonic acid. Among these acidic substances, volatile acids that are vaporized at the time of coating and drying the dispersion liquid, such as hydrochloric acid and nitric acid, are preferred.

Examples of the basic substance include sodium hydroxide, potassium hydroxide, calcium hydroxide and ammonia. Thereamong, volatile bases that are vaporized at the time of coating and drying the dispersion liquid, such as ammonia, are preferred.

The pH of the carbon nanotube dispersion liquid is adjusted by adding the above-described acidic substance and/or basic substance until a desired pH is attained while measuring the pH. Examples of the method of measuring the pH include a method in which a pH test paper such as litmus paper is used, a hydrogen electrode method, a quinhydrone electrode method, an antimony electrode method and a glass electrode method. Thereamong, a glass electrode method is preferred since it is simple and capable of providing the required accuracy. Further, in cases where an acidic substance or a basic substance was added excessively and the pH became higher than a desired value, the pH can be adjusted by adding a substance having the opposite property. As the acidic substance and the basic substance to be used in such adjustment, nitric acid and ammonia are preferred, respectively.

As the dispersion medium to be used for preparation of a carbon nanotube dispersion liquid used in the present invention, from the viewpoints that, for example, the above-described dispersant can be safely dissolved and the resulting waste liquid is easily treated, water is preferred.

The method of preparing the carbon nanotube dispersion liquid used in the present invention is not particularly restricted and the preparation can be performed by, for example, the following procedures. Since the treatment time at the time of dispersion can be shortened, it is preferred to once prepare a dispersion liquid which contains the carbon nanotube in the concentration range of 0.003 to 0.15% by mass in the dispersion medium and then dilute the resultant to a prescribed concentration. In the present invention, the mass ratio of the dispersant is preferably not higher than 10 with respect to the carbon nanotube. In such preferred range, uniform dispersion is easily attained and there is little effect of impairing the conductivity. The mass ratio of the dispersant to carbon nanotubes is more preferably 0.5 to 9, still more preferably 1 to 6, especially preferably 2 to 3. Examples of a dispersion means used in the preparation of the carbon nanotube dispersion liquid include mixing a carbon nanotube and a dispersant in a dispersion medium using a mixing/dispersion apparatus which is commonly used in the production of a coating (for example, a ball mill, a beads mill, a sand mill, a roll mill, a homogenizer, an ultrasonic homogenizer, a high-pressure homogenizer, an ultrasonic apparatus, an attritor, a desorber or a paint shaker). Further, dispersion may also be carried out stepwise by using a plurality of these mixing/dispersion apparatuses in combination. Thereamong, a method in which dispersion is carried out using an ultrasonic apparatus after performing preliminary dispersion using a vibration ball mil is preferred since the dispersibility of the carbon nanotube in the resulting dispersion liquid used for coating is favorable.

### [Formation of Carbon Nanotube Layer]

In the method for producing a transparent conductive laminate according to the present invention, a conductive layer containing carbon nanotubes (hereinafter, referred to as a carbon nanotube layer) is preferably formed through the coating step of coating a carbon nanotube dispersion liquid on an undercoat layer and the subsequent step of drying the resultant to remove a dispersion medium. In the coating step, it is believed that, when a dispersion liquid obtained by the above-described method is coated on an undercoat layer provided on a transparent substrate, a dispersant having a hydrophilic moiety is drawn and adsorbed to the surface of the undercoat layer having hydrophilicity because the dispersant contains an inorganic oxide. Subsequently, a carbon nanotube layer is formed by drying the dispersion medium and fixing the carbon nanotube on the undercoat layer. Here, it is believed that, due to the dispersion medium remaining on the undercoat layer, as long as the dispersant is in a condition where it is capable of moving from the carbon nanotube to the surface of the undercoat layer, the dispersant is drawn and adsorbed to the surface of the undercoat layer having a hydrophilic group in the same manner as in the coating step. In this manner, it is believed that the amount of the dispersant in the carbon nanotube layer is reduced by the adsorption of the dispersant to the undercoat layer containing an inorganic oxide. Such adsorption of the dispersant to the undercoat layer is caused to proceed satisfactorily by using a hydrophilic undercoat layer having a water contact angle of 5° to 25°. Further, it is preferred that the carbon nanotube dispersion liquid be coated at a coating thickness in the range of 1 μm to 50 μm and that the time for the dispersion medium to be removed from the carbon nanotube layer by drying be in the range of 0.1 second to 100 seconds since the adsorption of the dispersant by such mechanism can be more effectively generated.

A transparent conductive laminate prepared by coating and then drying a carbon nanotube dispersion liquid on a transparent substrate has the problem that bundling of carbon nanotubes occurs due to an increase in concentration of the dispersion liquid during drying after coating and generation of an electrostatic repulsive force between the carbon nanotube dispersion liquid and the transparent substrate. In the present invention, it has been found that when carbon nanotubes are negatively charged in a dispersion liquid, and the carbon nanotube dispersion liquid is coated on an undercoat layer having a solid surface zeta potential of +30 to −30 mV, and dried, the carbon nanotubes dispersed in the carbon nanotube dispersion liquid are electrostatically adsorbed to the undercoat layer, so that bundling of the carbon nanotubes occurring during drying on a transparent substrate can be suppressed, leading to the present invention. Consequently, a transparent conductive laminate having superior transparent conductivity as compared to conventional ones can be obtained.

In the method for producing a transparent conductive laminate according to the present invention, the method for coating a dispersion liquid on a transparent substrate is not particularly restricted. A known coating method, for example, spray coating, immersion coating, spin coating, knife coating, kiss coating, gravure coating, slot-die coating, bar coating, roll coating, screen printing, ink-jet printing, pad printing or other type of printing method may be employed. Further, the coating may be performed in plural times and two different coating methods may also be used in combination. As the coating method, gravure coating, bar coating and slot die coating are most preferred.

### [Thickness Adjustment of Carbon Nanotube Layer]

The coating thickness at which the carbon nanotube dispersion liquid is coated on the transparent substrate is also dependent on the concentration of the carbon nanotube dispersion liquid; therefore, the coating thickness can be adjusted as appropriate so that a desired surface resistance can be attained. In the present invention, the amount of carbon nanotube to be coated can be easily adjusted so as to achieve a variety of applications where conductivity is required. For example, it is preferred that the coating amount be 0.1 mg/m² to 5 mg/m² because the total light transmittance after overcoating as shown below can be made greater than 88%.

### [Overcoat Layer]

Preferably, the transparent conductive laminate of the present invention has an overcoat layer composed of a transparent coating film on the upper surface of the carbon nanotube layer. It is preferred that the transparent conductive laminate have an overcoat layer because the transparent conductivity, heat resistance stability and moist-heat resistance stability can be further improved.

As the material of the overcoat layer, either of an organic material and an inorganic material can be used; however, from the standpoint of the resistance stability, an inorganic material is preferred. Examples of the inorganic material include metal oxides such as silica, tin oxide, alumina, zirconia and titania, and from the standpoint of the resistance stability, silica is preferred.

### [Method of Forming Overcoat Layer]

In the method for producing a transparent conductive laminate according to the present invention, the method for providing an overcoat layer on a carbon nanotube layer is not particularly restricted. A known wet coating method, for example, spray coating, immersion coating, spin coating, knife coating, kiss coating, roll coating, gravure coating, slot-die coating, bar coating, screen printing, ink-jet printing, pad printing or other type of printing method may be employed. Further, a dry coating method may be employed as well. As the dry coating method, for example, physical vapor growth, such as sputtering or vapor deposition, or chemical vapor deposition can be utilized. Further, the operation of providing an overcoat layer on a carbon nanotube layer may be performed in plural times and two different coating methods may also be used in combination. As the method, gravure coating, bar coating and slot die coating, which are wet coating, are preferred.

In the method of forming a silica layer using wet coating, it is preferred to use an organic silane compound, and examples of such method include a method in which the above-described wet coating is performed using, as a coating solution, a solution which is prepared by dissolving a silica sol produced by hydrolyzation of an organic silane compound such as tetraalkoxysilane (e.g. tetramethoxysilane, tetraethoxysilane, tetra-n-propoxysilane, tetra-iso-propoxysilane or tetra-n-butoxysilane) in a solvent and at the time of drying the solvent, silanol groups are allowed to undergo dehydration condensation with each other to form a silica thin film.

The thickness of the overcoat layer is controlled by adjusting the concentration of the silica sol in the coating solution and the coating thickness at the time of coating. Any thickness at which an anti-reflection effect by optical interference can be effectively attained is preferred since such a thickness allows an improvement in the light transmittance. Accordingly, as described in the above, it is preferred that the thickness of the overcoat layer be, combined with that of the undercoat layer, in the range of 80 to 120 nm. Further, by increasing the thickness of the overcoat layer, scattering of a dopant improving the conductivity of the carbon nanotube, such as nitric acid, can be prevented and heat resistance can be improved. The thickness of the overcoat layer effective in preventing this scattering of a dopant is not less than 40 nm. Further, considering the range of the total thickness of the undercoat layer and the overcoat layer for attaining the above-described anti-reflection effect, it is more preferred that the thickness of the overcoat layer be not less than 40 nm and not greater than 110 nm.

### EXAMPLES

The present invention will now be described in more detail by way of examples thereof; however, the present invention is not restricted thereto. The measurement methods used in the examples are described below. Unless otherwise specified, the number of measurements, n, was 2 and an average value thereof was used.

### (1) Water Contact Angle

In an atmosphere having a room temperature of 25° C. and a relative humidity of 50%, 1 to 4 μL of water was dropped onto the film surface using a syringe. Using a contact angle meter (model CA-X manufactured by Kyowa Interface Science Co., Ltd.), a droplet was observed from a horizontal cross-section to determine the angle created between a tangent line of the droplet edge and the film plane.

(2) Wettability of Carbon Nanotube Dispersion Liquid with Surface of Undercoat Layer or PET Substrate

As for the wettability of a carbon nanotube dispersion liquid with a surface of undercoat layer or a surface of PET substrate, the carbon nanotube dispersion liquid was coated and dry-fixed on the above-described surface of undercoat layer or the surface of PET substrate and the resulting dry carbon nanotube coating film was visually observed. When the coating film was uniformly formed, the wettability was judged as satisfactory, and when the coating film was not uniformly formed, the wettability was judged as poor.

### (3) Solid Surface Zeta Potential

A transparent substrate provided with an undercoat layer was sampled so as to meet a size of a solid surface zeta potential measuring cell, and set at a solid surface zeta potential. Measurement was performed using ELS-Z2 manufactured by Otsuka Electronics Co., Ltd. At this time, the refractive index and viscosity of water were input beforehand, measurement was performed three times at a set temperature of 25° C., and an average value of the measurements was determined.

### (4) Measurement of Surface Roughness Ra

For the surface roughness Ra, the surface of a transparent conductive laminate was measured with an AFM (Shimadzu, SPM 9600 etc.), and then performing roughness analysis using attached dedicated software.

As an AFM cantilever, a noncontact mode high resonance frequency type probe model PPP-NCHR (NANOSENSORS Inc.) was used.

Measurement was performed under conditions of a scanning speed of 0.5 Hz and a pixel number of 512×512 in a visual field of 1 μm×1 μm, the obtained data was processed based on JIS Standard JIS B 0601 (2001), and an arithmetic mean roughness Ra was calculated.

### (5) Zeta Potential of Carbon Nanotube Dispersion Liquid

One (1) mL of the carbon nanotube dispersion liquid was sampled, and diluted so that the content of carbon nanotubes was 0.003% by mass. The diluted carbon nanotube dispersion liquid was transferred to a solution zeta potential measuring cell, and a zeta potential was measured using ELS-Z2 manufactured by Otsuka Electronics Co., Ltd. At this time, the refractive index and viscosity of water were input beforehand, measurement was performed three times at a set temperature of 25° C., and an average value of the measurements was determined.

### (6) Measurement of Bundle Diameter on Transparent Substrate

A sample with a carbon nanotube layer having a light absorptivity of 5% before overcoat treatment was observed in two visual fields at an accelerating voltage of 2.0 kV and a magnification of 100,000 using scanning electron microscope (Hitachi, SU8000) capable of observation without depositing a metal. Three longitudinal lines laterally quadrisecting a microscopic image obtained for each visual field were drawn, and bundle diameters of carbon nanotubes present at intersections with the three lines were all measured. When the number of carbon nanotubes present at intersections with the three lines was less than 50, four lines were drawn midway between the three lines so as to extend in parallel to the three lines, and bundle diameters of carbon nanotubes present at intersections with the four lines were measured as well. In this way, the number of carbon nanotubes to be measured was 50 or more per visual field, and an average value was calculated for all the carbon nanotubes in two fields.

### (7) Total Light Transmittance

In accordance with JIS K 7361 (1997), the total light transmittance was measured using a turbidimeter NDH2000 manufactured by NIPPON DENSHOKU INDUSTRIES CO., LTD.

### (8) White Reflectance

Using “LUMIRROR” (registered trademark) ES6R manufactured by TORAY INDUSTRIES, INC. as a white reflection plate and “LUCIACS” (registered trademark) CS9621T manufactured by NITTO DENKO CORPORATION as an adhesive layer, they were laminated such that, as shown in FIG. 1, the conductive surface of the transparent conductive laminate was in contact with the adhesive layer. On the transparent conductive laminate side of the thus obtained laminate, the reflectance at a wavelength of 550 nm was measured using “CM-2500d” manufactured by Konica Minolta Sensing, Inc., and the thus obtained value was defined as white reflectance.

### (9) Surface Resistance

A transparent conductive laminate was sampled in a size of 5 cm×10 cm and a probe was brought into close contact with the central part of the carbon nanotube layer side of the thus sampled transparent conductive laminate to measure the resistance by a four-probe method at room temperature. A resistivity meter, model MCP-T360 manufactured by DIA Instruments Co., Ltd., was employed as the measuring apparatus and a four-point probe, MCP-TPO3P manufactured by DIA Instruments Co., Ltd., was employed as the probe.

### (10) Moist-Heat Resistance Stability

A transparent conductive laminate was sampled in a size of 5 cm×10 cm and subjected to the following moist-heat treatment. The surface resistance of the sample after the moist-heat treatment was divided by the surface resistance of the sample prior to the moist-heat treatment and the thus obtained value was used as an index of the moist-heat resistance stability.

Moist-heat treatment: the following treatments (i) and (ii) were carried out consecutively.

(i) retaining the sample for 1 hour in a moist-heat oven having a temperature of 60° C. and a relative humidity of 90%; and
(ii) leaving the resulting sample for 3 minutes to stand in an atmosphere having a room temperature of 25° C. and a relative humidity of 50%.

### (11) Heat Resistance Stability

A transparent conductive laminate was sampled in a size of 5 cm×10 cm and subjected to the following heat treatment. The surface resistance of the sample after the heat treatment was divided by the surface resistance of the sample prior to the heat treatment and the thus obtained value was used as an index of the heat resistance stability.

Heat treatment: the following treatments (iii) and (iv) were carried out consecutively.

(iii) retaining the sample for 1 hour in a 150° C. hot-air oven; and
(iv) leaving the resulting sample to stand for 24 hours in an atmosphere having a room temperature of 25° C. and a relative humidity of 50%.

### [Undercoat Layer Formation Example]

By the following operations, a hydrophilic silica undercoat layer containing silica microparticles of about 30 nm in diameter exposed on the surface was formed using polysilicate as a binder.

A Mega Aqua Hydrophilic DM Coat (DM-30-26G-N1; manufactured by Ryowa Corporation) containing hydrophilic silica microparticles of about 30 nm in diameter and polysilicate was used as a coating solution for silica film formation.

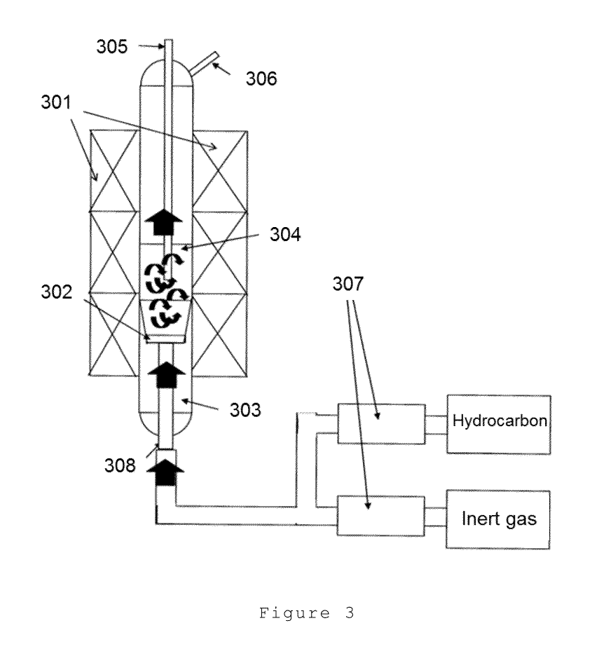

Using a #3 wire bar, the above-described coating solution for silica film formation was coated on a 188 μm-thick biaxially-stretched polyethylene terephthalate film (“LUMIRROR” (registered trademark) U46) manufactured by TORAY INDUSTRIES, INC. Then, the resultant was dried for 1 minute in a dryer at 80° C. FIG. 2 shows a surface AFM image. The thickness of the undercoat layer prepared in this method was 40 nm.

### [Undercoat Layer Formation Example 2]

By the following operations, a hydrophilic alumina undercoat layer containing alumina microparticles of 15 to 30 nm in diameter exposed on the surface was formed using polysilicate as a binder.

To a hydrophilic alumina sol of 15 to 30 nm in diameter (AS520 manufactured by Nissan Chemical Industries, Ltd.) was added 10% by mass of a hydrophilic polysilicate (COLCOAT N103X manufactured by COLCOAT CO., Ltd), and the mixture was used as a coating solution for undercoat layer formation.

Using a #3 wire bar, the above-described coating solution for undercoat layer formation was coated on a 100 μm-thick biaxially-stretched polyethylene terephthalate film (“LUMIRROR” (registered trademark) U46) manufactured by TORAY INDUSTRIES, INC. Then, the resultant was dried for 1 minute in a dryer at 80° C. The thickness of the undercoat layer prepared in this method was 40 nm.

### [Substrate Surface Treatment Example]

An operation of moving an electrode to “LUMIRROR” (registered trademark) U46 manufactured by TORAY INDUSTRIES, INC., at an output of 100 W and a speed of 6.0 m/min, with a distance of 1 mm kept between the electrode and a transparent substrate using a corona surface modification and evaluation apparatus TEC-4AX (manufactured by KASUGA ELECTRIC WORKS LTD.) was performed five times. By this treatment, the hydrophilicity of the substrate surface was improved and the water contact angle was reduced from 56° to 43°.

### [Catalyst Preparation Example: Catalyst Metal Salt Supported on Magnesia]

Ferric ammonium citrate (2.46 g; manufactured by Wako Pure Chemical Industries, Ltd.) was dissolved in 500 mL of methanol (manufactured by Kanto Chemical Co., Inc.). To the resulting solution, 100.0 g of magnesium oxide (MJ-30 manufactured by Iwatani Chemical Industry Co., Ltd.) was added and vigorously stirred for 60 minutes using a stirrer. The resulting suspension was concentrated to dryness under reduced pressure at 40° C. The thus obtained powder was heat-dried at 120° C. to remove methanol, thereby obtaining a catalyst in which a metal salt was supported on magnesium oxide powder. The thus obtained solid content was pulverized using a mortar and sieved to recover particles having a particle size in the range of 20 to 32-mesh (0.5 to 0.85 mm). The obtained catalyst had an iron content of 0.38% by mass, and a bulk density of 0.61 g/mL. The above-described operations were repeated and the resultants were subjected to the following experiments.

### [Carbon Nanotube Assembly Production Example: Synthesis of Carbon Nanotube Assembly]

Using the apparatus shown in FIG. 3, a carbon nanotube was synthesized. A reactor 303 is a cylindrical quartz tube of 75 mm in inner diameter and 1,100 mm in length. The reactor is equipped with a quartz sintered plate 302 in the central part; a mixed gas introduction pipe 308, which is an inert gas and material gas supply line, in the lower part of the quartz tube; and a waste gas pipe 306 in the upper part. Further, the reactor is also equipped with three electric furnaces 301 as heaters surrounding the periphery thereof such that the reactor can be maintained at an arbitrary temperature. The reactor is equipped with a thermocouple 305 as well for detecting the temperature inside the reactor tube.

A catalyst layer 304 was formed by introducing 132 g of the solid catalyst prepared in Catalyst Preparation Example onto the quartz sintered plate provided in the central part of the reactor arranged in the vertical direction. While heating the thus formed catalyst layer, using a mass flow controller 307, a nitrogen gas was fed at a rate of 16.5 L/min from the bottom part of the reactor toward the upper part thereof and allowed to pass through the catalyst layer until the temperature inside the reactor tube became about 860° C. Thereafter, while feeding a nitrogen gas, using the mass flow controller 307, a methane gas was further introduced at a rate of 0.78 L/min for 60 minutes and allowed to pass through the catalyst layer, thereby performing a reaction. Here, the contact time (W/F), which is obtained by dividing the weight of the solid catalyst with the flow rate of methane, was 169 min-g/L and the linear velocity of the methane-containing gas was 6.55 cm/sec. The feeding of methane gas was terminated and the quartz reactor tube was cooled to room temperature while passing nitrogen gas therethrough at a rate of 16.5 L/min.

Heating was terminated and the reactor was left to cool to room temperature. Then, once the reactor was cooled to room temperature, the resulting carbon nanotube-containing composition containing the catalyst and carbon nanotube was taken out therefrom.

### [Purification and Oxidation Treatment of Carbon Nanotube Assembly]

In 2,000 mL of 4.8 N hydrochloric acid aqueous solution, 130 g of the carbon nanotube-containing composition containing the catalyst and carbon nanotube, which was obtained in Carbon Nanotube Assembly Production Example, was stirred for 1 hour to dissolve iron which is the catalyst metal and MgO which is the carrier thereof. After filtering the resulting black suspension, the thus obtained filtration product was again placed in 400 mL of 4.8 N hydrochloric acid aqueous solution to perform a MgO removal treatment and the resultant was filtered. The operation was repeated three times (MgO removal treatment). Then, after washing the resultant with ion-exchanged water until the suspension of filtration product became neutral, the resulting carbon nanotube-containing composition was stored in wet condition with water. Here, the total weight of the carbon nanotube-containing composition in wet condition with water was 102.7 g (concentration of carbon nanotube-containing composition: 3.12% by mass).

To the thus obtained carbon nanotube-containing composition in wet condition, a concentrated nitric acid (manufactured by Wako Pure Chemical Industries, Ltd.; first class, assay 60 to 61%) was added in a weight of about 300 times of the dry weight of the carbon nanotube-containing composition. Then, in an oil bath at about 140° C., the resulting mixture was heated to reflux with stirring for 25 hours. Thereafter, the resulting nitric acid solution containing the carbon nanotube-containing composition was 3-fold diluted with ion-exchanged water and suction-filtered. After washing the resultant with ion-exchanged water until the suspension of filtration product became neutral, a carbon nanotube assembly was obtained in wet condition with water. Here, the total weight of the carbon nanotube-containing composition in wet condition with water was 3.351 g (concentration of carbon nanotube-containing composition: 5.29 wt %).

### [Preparation of Carbon Nanotube Dispersion Liquid 1]

The thus obtained carbon nanotube assembly in wet condition (25 mg based on dry weight), 1.04 g of 6% by mass sodium carboxymethyl cellulose aqueous solution (CELLOGEN 7A manufactured by Dai-Ichi Kogyo Seiyaku Co., Ltd. (weight average molecular weight: 190,000)) and 6.7 g of zirconia beads (“TORAYCERAM” (registered trademark) manufactured by TORAY INDUSTRIES, INC.; beads size: 0.8 mm) were added to a container, and the resulting dispersion liquid was adjusted to have a pH of 10 by adding thereto 28% by mass aqueous ammonia solution (manufactured by Kishida Chemical Co., Ltd.). This container was shaken for 2 hours using a vibration ball mill (VS-1 manufactured by IRIE SHOKAI Co., Ltd.; vibration rate: 1,800 cpm (60 Hz)) to prepare a carbon nanotube paste.

Then, the thus obtained carbon nanotube paste was diluted with ion-exchanged water to a carbon nanotube concentration of 0.15% by mass and 10 g of the resulting diluent was again adjusted to have a pH of 10 by adding thereto a 28% by mass aqueous ammonia solution. The thus obtained aqueous solution was subjected to a 1.5-minute dispersion treatment with ice cooling, using an ultrasonic homogenizer (VCX-130 manufactured by IEDA TRADING CORPORATION) at an output of 20 W (1 kW-min/g). During this dispersion treatment, the solution temperature was maintained at not higher than 10° C. The resulting solution was centrifuged at 10,000 G for 15 minutes using a high-speed centrifuge (MX-300 manufactured by TOMY SEIKO CO., LTD.) to obtain a carbon nanotube dispersion liquid in an amount of 9 g.

### [Preparation of Carbon Nanotube Dispersion Liquid 2]

The thus obtained carbon nanotube assembly in wet condition (25 mg based on dry weight), 1.04 g of 6% by mass sodium carboxymethyl cellulose aqueous solution (weight average molecular weight: 35,000)) and 6.7 g of zirconia beads (“TORAYCERAM” (registered trademark) manufactured by TORAY INDUSTRIES, INC.; beads size: 0.8 mm) were added to a container, and the resulting dispersion liquid was adjusted to have a pH of 10 by adding thereto 28% by mass aqueous ammonia solution (manufactured by Kishida Chemical Co., Ltd.). This container was shaken for 2 hours using a vibration ball mill (VS-1 manufactured by IRIE SHOKAI Co., Ltd.; vibration rate: 1,800 cpm (60 Hz)) to prepare a carbon nanotube paste.

Then, the thus obtained carbon nanotube paste was diluted with ion-exchanged water to a carbon nanotube concentration of 0.15% by mass and 10 g of the resulting diluent was again adjusted to have a pH of 10 by adding thereto a 28% by mass aqueous ammonia solution. The thus obtained aqueous solution was subjected to a 1.5-minute dispersion treatment with ice cooling, using an ultrasonic homogenizer (VCX-130 manufactured by IEDA TRADING CORPORATION) at an output of 20 W (1 kW·min/g). During this dispersion treatment, the solution temperature was maintained at not higher than 10° C. The resulting solution was centrifuged at 10,000 G for 15 minutes using a high-speed centrifuge (MX-300 manufactured by TOMY SEIKO CO., LTD.) to obtain a carbon nanotube dispersion liquid in an amount of 9 g.

### Reference Example

### Production of Carboxymethylcellulose Having Weight Average Molecular Weight of 35,000

Five hundred (500) g of 10% by mass sodium carboxymethyl cellulose aqueous solution (CELLOGEN 5A manufactured by Dai-Ichi Kogyo Seiyaku Co., Ltd. (weight average molecular weight: 80,000)) was added to a three-way flask and adjusted to have a pH of 2 using first class sulfuric acid (manufactured by Kishida Chemical Co., Ltd.). The container was transferred to an oil bath heated to 120° C., and the solution was subjected to a hydrolysis reaction for 9 hours while being stirred under heating and reflux. The three-way flask was allowed to cool, and the solution was then adjusted to have a pH of 10 using a 28% aqueous ammonia solution (manufactured by Kishida Chemical Co., Ltd.), so that the reaction was stopped. A weight average molecular weight of sodium carboxymethyl cellulose after hydrolysis was calculated by referring to a calibration curve from polyethylene glycol using a gel permeation chromatography method. As a result, the weight average molecular weight was about 35,000, and the molecular weight distribution (Mw/Mn) was 1.5. The yield was 97%. Twenty (20) g of the 10% by mass the sodium carboxymethyl cellulose aqueous solution (weight average molecular weight: 35,000) was added to a dialysis tube cut to 30 cm (Biotech CE Dialysis Tube manufactured by Spectrum Laboratories, Inc. (cutoff molecular weight: 3,500 to 5,000 D, 16 mmφ), and the dialysis tube was floated in a beaker containing 1,000 g of ion-exchanged water, so that dialysis was performed for 2 hours. Thereafter, the ion-exchanged water was replaced by 1,000 g of fresh ion-exchanged water, and dialysis was performed again for 2 hours. This operation was repeated three times, dialysis was performed for 12 hours in a beaker containing 1,000 g of fresh ion-exchanged water, and the sodium carboxymethyl cellulose aqueous solution was drawn out from the dialysis tube. The aqueous solution was concentrated under reduced pressure using an evaporator, and dried using a freeze dryer. As a result, powdered sodium carboxymethyl cellulose was obtained in a yield of 70%. The weight average molecular weight measured by the gel permeation chromatography method was comparable to that before dialysis. For the peak area in the gel permeation chromatography spectrum, the peak area of sodium carboxymethyl cellulose before dialysis was 57%, whereas after dialysis, the peak area of ammonium sulfate was decreased and the peak area of sodium carboxymethyl cellulose was increased to 91%. The ratio of the absorbance at a wavelength of 280 nm in the ultraviolet and visible absorption spectrum to that of 0.1% by weight aqueous solution of sodium carboxymethyl cellulose (CELLOGEN 5A manufactured by Dai-Ichi Kogyo Seiyaku Co., Ltd. (weight average molecular weight: 80,000) as a raw material was 20 before dialysis and 2 after dialysis. The degree of etherification was 0.7 both before and after hydrolysis.

### [Formation of Carbon Nanotube Layer]

Ion-exchanged water was added to the above-described carbon nanotube dispersion liquid to adjust the amount of carbon nanotube to 0.02% by mass to 0.04% by mass. Then, the resulting carbon nanotube dispersion liquid was, using a wire bar, coated on a transparent substrate provided with the undercoat layer or a surface-treated transparent substrate on which the above-described undercoat was formed, and the resultant was dried for 1 minute in a dryer at 80° C. to fix the carbon nanotube composition. The light transmittance was adjusted by adjusting the above-described carbon nanotube concentration and wire bar number.

### [Overcoat Layer Formation Example]

In a 100-mL plastic container, 20 g of ethanol was placed and 40 g of n-butyl silicate was added thereto and stirred for 30 minutes. Then, after adding thereto 10 g of 0.1N hydrochloric acid aqueous solution, the resultant was stirred for 2 hours and left to stand at 4° C. for 12 hours. The resulting solution was diluted with a mixed solution of toluene, isopropyl alcohol and methyl ethyl ketone to a solids concentration of 1% by mass.

The thus obtained coating solution was coated on a carbon nanotube layer using a #8 wire bar. Then, the resultant was dried for 1 minute in a dryer at 125° C. The thickness of the overcoat layer prepared in this method was 60 nm.

### Example 1

An undercoat layer was formed in accordance with [Undercoat Layer Formation Example 1]. A carbon nanotube layer was formed on the undercoat layer with a wire bar number #3 using a coating solution with a carbon nanotube dispersion liquid 1 adjusted to have a concentration of 0.04 wt %. Then, on this carbon nanotube layer, an overcoat layer was formed by the method of [Overcoat Layer Formation Example] to prepare a transparent conductive laminate.

### Examples 2 to 7 and Comparative Examples 1 to 4

Transparent conductive laminates were prepared in the same manner as in Example 1 except the substrate surface treatment, undercoat layer formation conditions, the carbon nanotube dispersion liquid and coating concentration, and the wire bar number during coating of the carbon nanotube dispersion liquid were combined as shown in Example 1.

TABLE 1

| | Substrate surface | | Wire bar number | Carbon nanotube |
|---|---|---|---|---|
| | treatment or | | during coating of | coating |
| | undercoat layer | Carbon nanotube | carbon nanotube | concentration |
| | preparation conditions | dispersion liquid | dispersion liquid | (wt %) |
| Example 1 | Undercoat layer | Carbon nanotube | #3 | 0.04 |
| | preparation example 1 | dispersion liquid 1 | | |
| Example 2 | Undercoat layer | Carbon nanotube | #4 | 0.04 |
| | preparation example 1 | dispersion liquid 1 | | |
| Example 3 | Undercoat layer | Carbon nanotube | #3 | 0.02 |
| | preparation example 1 | dispersion liquid 1 | | |
| Example 4 | Undercoat layer | Carbon nanotube | #5 | 0.04 |
| | preparation example 1 | dispersion liquid 1 | | |
| Example 5 | Undercoat layer | Carbon nanotube | #5 | 0.04 |
| | preparation example 2 | dispersion liquid 1 | | |
| Example 6 | Undercoat layer | Carbon nanotube | #5 | 0.04 |
| | preparation example 1 | dispersion liquid 2 | | |
| Example 7 | Undercoat layer | Carbon nanotube | #5 | 0.04 |
| | preparation example 2 | dispersion liquid 2 | | |
| Comparative | Corona treatment | Carbon nanotube | #3 | 0.04 |
| Example 1 | | dispersion liquid 1 | | |
| Comparative | Corona treatment | Carbon nanotube | #4 | 0.04 |
| Example 2 | | dispersion liquid 1 | | |
| Comparative | Corona treatment | Carbon nanotube | #3 | 0.02 |
| Example 3 | | dispersion liquid 1 | | |
| Comparative | — | Carbon nanotube | #3 | 0.04 |
| Example 4 | | dispersion liquid 1 | | |

Table 2 shows, with regard to Examples 1 to 7 and Comparative Examples 1 to 4: water contact angle of the surface of the undercoat layer or the PET transparent substrate; wettability of the carbon nanotube dispersion liquid with the surface of the undercoat layer or the PET transparent substrate; zeta potential of the undercoat layer or PET transparent substrate surface; surface roughness of the undercoat layer or PET transparent substrate surface; zeta potential of the carbon nanotube liquid; bundle diameter; total light transmittance; white reflectance; surface resistance; heat resistance stability; and moist-heat resistance stability. In Table 2, “-” denotes the absence of corresponding item.

TABLE 2

| | | Wettability | | | | | | | | | |
|---|---|---|---|---|---|---|---|---|---|---|---|
| | Water | of carbon | | Surface | | | | | | | |
| | contact | nanotube | Zeta | roughness | | Bundle | | | | | |
| | angle (°) | dispersion | potential | Ra of | Zeta | diameter | | | | | |
| | of | liquid with | (mV) of | undercoat | potential | on | Total | | | | Moist- |
| | undercoat | surface of | undercoat | or PET | (mv) of | trans- | light | White | Surface | Heat | heat |
| | or PET | undercoat | or PET | substrate | carbon | parent | transmit- | reflec- | resis- | resis- | resis- |
| | substrate | or PET | substrate | surface | nanotube | substrate | tance | tance | tance | tance | tance |
| | surface | substrate | surface | (nm) | liquid | (nm) | (%) | (%) | (Ω/□ ) | stability | stability |
| Exam- | 5.5 | Good | −17.7 | 4.5 | −60.0 | 4.5 | 92.3 | 83 | 3,700 | 1.0 | 0.8 |
| ple 1 | | | | | | | | | | | |
| Exam- | 5.5 | Good | −17.7 | 4.5 | −60.0 | 4.8 | 90.9 | 76 | 680 | 1.0 | 1.1 |
| ple 2 | | | | | | | | | | | |
| Exam- | 5.5 | Good | −17.7 | 4.5 | −60.0 | 4.4 | 93.0 | 84 | 6,170 | 1.0 | 1.0 |
| ple 3 | | | | | | | | | | | |
| Exam- | 5.5 | Good | −17.7 | 4.5 | −60.0 | 4.9 | 89.2 | 73 | 500 | 1.1 | 1.1 |
| ple 4 | | | | | | | | | | | |
| Exam- | 7.4 | Good | 10.8 | 6.3 | −60.0 | 4.3 | 89.6 | 73 | 380 | 1.2 | 1.2 |
| ple 5 | | | | | | | | | | | |
| Exam- | 5.5 | Good | −17.7 | 4.5 | −62.9 | 4.0 | 90.1 | 73 | 450 | 1.3 | 1.2 |
| ple 6 | | | | | | | | | | | |
| Exam- | 7.4 | Good | 10.8 | 6.3 | −62.9 | 3.9 | 90.1 | 73 | 450 | 1.1 | 1.2 |
| ple 7 | | | | | | | | | | | |
| Compar- | 43 | Good | −51.0 | 1.7 | −60.0 | 5.7 | 92.5 | 83 | 5,000 | 1.6 | 1.5 |
| ative | | | | | | | | | | | |
| Exam- | | | | | | | | | | | |
| ple 1 | | | | | | | | | | | |
| Compar- | 43 | Good | −51.0 | 1.7 | −60.0 | 6.1 | 90.8 | 76 | 1,100 | 1.5 | 1.7 |
| ative | | | | | | | | | | | |
| Exam- | | | | | | | | | | | |
| ple 2 | | | | | | | | | | | |
| Compar- | 43 | Good | −51.0 | 1.7 | −60.0 | 5.5 | 93.0 | 84 | 16,000 | 1.7 | 1.6 |
| ative | | | | | | | | | | | |
| Exam- | | | | | | | | | | | |
| ple 3 | | | | | | | | | | | |
| Compar- | 56 | Cissing | −40.0 | — | −60.0 | — | — | — | — | — | — |
| ative | | | | | | | | | | | |
| Exam- | | | | | | | | | | | |
| ple 4 | | | | | | | | | | | |

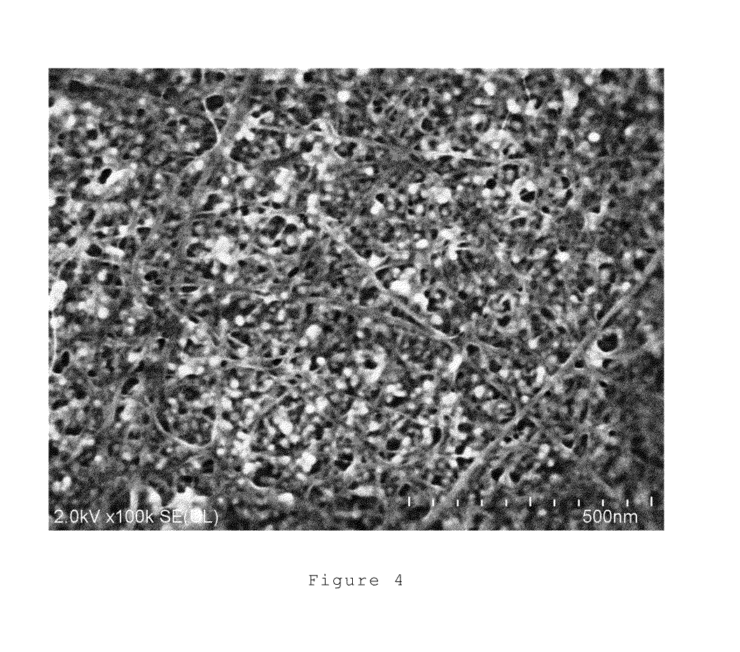

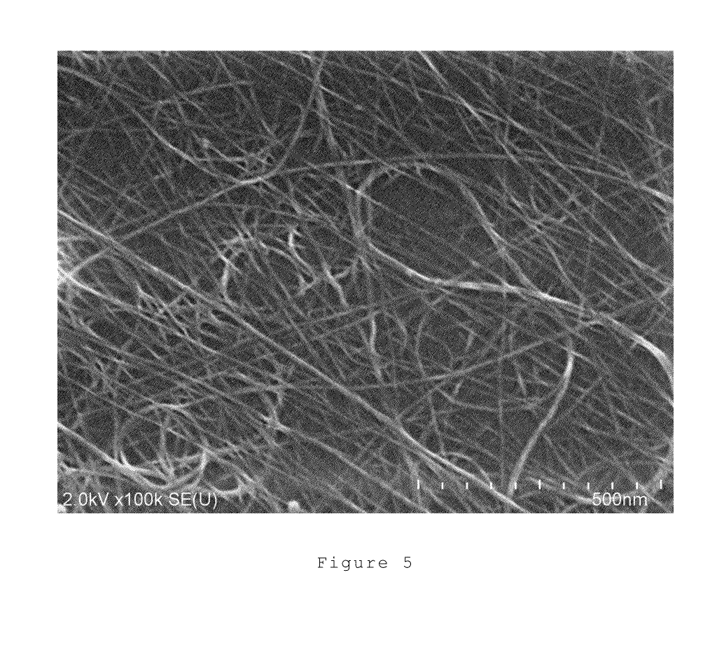

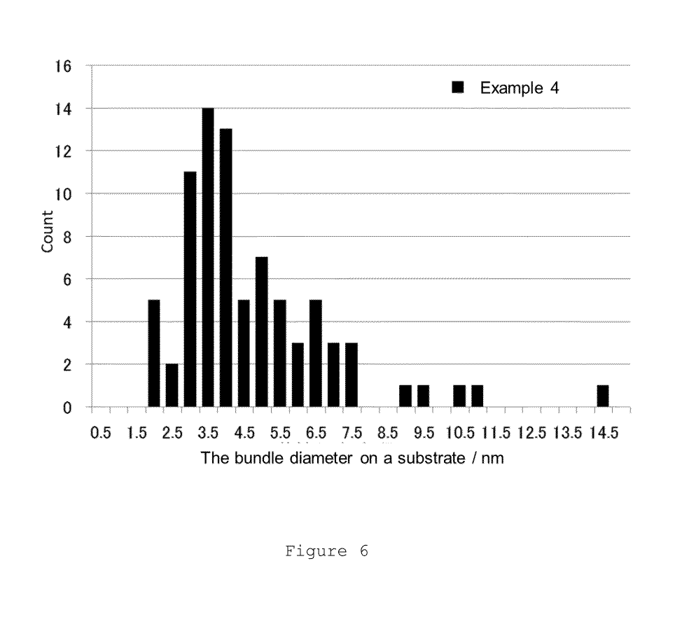

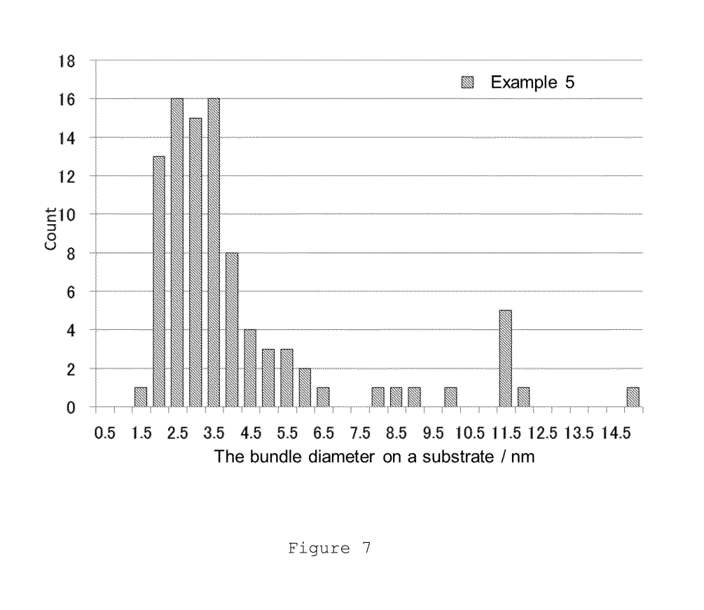

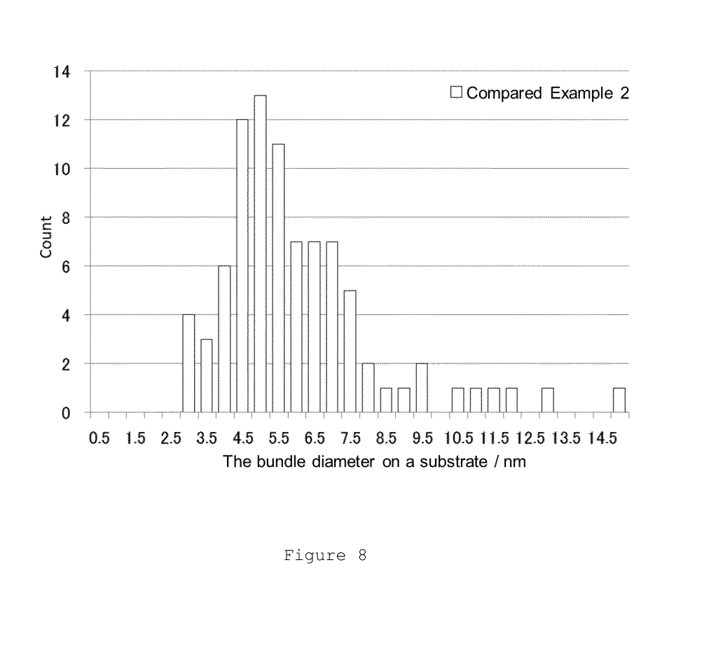

Comparison of example 1 with Comparative example 1 shows that the surface resistance in Example is lower at the same total light transmittance and white reflectance, and therefore provision of an undercoat layer having a hydrophilicity of 5° to 25°, a zeta potential of +30 mV to −30 mV and a surface roughness of 2 nm to 10 nm leads to an effect of improving transparent conductivity. It is apparent from observation of heat resistance and moist-heat resistance that samples provided with an undercoat layer have enhanced resistance stability. Comparison of Example 2 with Comparative Example 2 and Example 3 with Comparative Example 3 shows that a similar effect is obtained even when there is a difference in thickness of the CNT layer. Examples 1 to 7 show that when an undercoat layer having the characteristics of the patent is used, the transparent conductivity can be adjusted at a resistance of not less than 100Ω/□ and not more than 10,000Ω/□, a total light transmittance of not less than 88% and not more than 93% or a white reflectance of not less than 70% and not more than 85% and the bundle diameter can be reduced to 5 nm or less, so that the transparent conductivity can be improved, and further, a transparent conductive laminate having excellent resistance stability can be obtained. Examples of scanning electron microscopic images before overcoating in Example 4 and Comparative Example 2 are shown in FIGS. 4 and 5, respectively, and results of measurement of bundle diameters determined from these scanning electron microscopic images are shown in FIGS. 6, 7 and 8. For Examples and Comparative Examples, similar measurement was performed to determine a bundle diameter. Comparison of Examples 4 and 6 with Comparative Examples 5 and 7 shows that when alumina is used rather than silica as microparticles in the undercoat, the zeta potential can be adjusted to be more positive, and resultantly a transparent conductive laminate having transparent conductivity equivalent to or higher than that of silica microparticles can be obtained. Comparative Example 4 shows that in a substrate having a high water contact angle, cissing occurs during CNT coating, so that a CNT layer cannot be formed.

The transparent conductive laminate according to the present invention which has transparent conductivity, heat resistance stability and moist-heat resistance stability can be preferably used, for example, as an electrode related to displays such as touch panels, liquid crystal displays, organic electroluminescences and electronic papers.

### DESCRIPTION OF REFERENCE SIGNS

101: White reflection plate
102: Adhesive layer
103: Transparent conductive laminate
104: Conductive layer
105: Transparent substrate
301: Electric furnace
302: Quartz sintered plate
303: Reactor
304: Catalyst layer
305: Thermocouple
306: Waste gas pipe
307: Mass flow controller
308: Mixed gas introduction pipe

1. A transparent conductive laminate which comprises an undercoat layer containing an inorganic oxide and a conductive layer containing a carbon nanotube in this order on a transparent substrate, wherein at least one of the following conditions [A] and [B] is satisfied and the ratio of the surface resistance after subjecting the transparent conductive laminate to a 1-hour moist-heat treatment at a temperature of 60° C. and a relative humidity of 90% and then leaving the resultant to stand for 3 minutes at a temperature of 25° C. and a relative humidity of 50% is 0.7 to 1.3 with respect to the surface resistance prior to the treatment:
[A] the white reflectance is more than 70% and not more than 85% and the surface resistance is not less than 1.0×10²Ω/□ and not more than 1.0×10⁴Ω/□; and
[B] the total light transmittance is more than 88% and not more than 93%, and the surface resistance is not less than 1.0×10²Ω/□ and not more than 1.0×10⁴Ω/□.

2. The transparent conductive laminate according to claim 1, wherein the ratio of the surface resistance after subjecting the transparent conductive laminate to a 1-hour heat treatment at a temperature of 150° C. and then leaving the resultant to stand for 24 hours at a temperature of 25° C. and a relative humidity of 50% is 0.7 to 1.3 with respect to the surface resistance prior to the treatment.

3. The transparent conductive laminate according to claim 1, wherein the average of carbon nanotube bundle diameters on the transparent substrate is 5 nm or less as observed with a scanning electron microscope.

4. The transparent conductive laminate according to claim 1, wherein the undercoat layer is a complex of silica microparticles and a polysilicate.

5. The transparent conductive laminate according to claim 1, wherein the undercoat layer is a complex of alumina microparticles and a polysilicate.

6. The transparent conductive laminate according to claim 4, wherein the diameter of the silica microparticle or alumina microparticle is in the range of 10 nm to 200 nm.

7. A method for production of a transparent conductive laminate, which comprises: an undercoat layer forming step of providing an undercoat layer having a solid surface zeta potential of +30 to −30 mV; a coating step of coating a carbon nanotube dispersion liquid, whose zeta potential is negative, on the undercoat layer; and drying step of removing a dispersion medium from the carbon nanotube dispersion liquid coated on the undercoat layer.

8. The method for production of a transparent conductive laminate according to claim 7, wherein the surface roughness Ra of the undercoat layer is 2.0 to 10.0 nm.

9. The method for production of a transparent conductive laminate according to claim 7, wherein the water contact angle of the undercoat layer is 5 to 25°.

10. The method for production of a transparent conductive laminate according to claim 7, wherein the zeta potential of the carbon nanotube dispersion liquid is −40 to −70 mV.

11. An electronic paper, comprising the transparent conductive laminate according to claim 1.

12. A touch panel, comprising the transparent conductive laminate according to claim 1.
